(19) United States
(12) Patent Application Publication
(10) Pub. No.: US 2022/0157346 A1
(43) Pub. Date: May 19, 2022

(54) CALIBRATION OF A CAMERA PROVIDED FOR MONITORING AN ADDITIVE MANUFACTURING PROCESS

(71) Applicant: Siemens Aktiengesellschaft, München (DE)

(72) Inventors: Frank Forster, München (DE); Andreas Graichen, Norrköping (SE); Claudio Laloni, Taufkirchen (DE); Clemens Otte, München (DE)

(21) Appl. No.: 17/602,003

(22) PCT Filed: Mar. 26, 2020
(86) PCT No.: PCT/EP2020/058492

§ 371 Date: Oct. 7, 2021

(30) Foreign Application Priority Data
Apr. 15, 2019 (EP) 19169185.6

(51) Int. Cl. G11B 27/30; H04N 5/93; G11B 27/32; H04N 9/82

(52) U.S. Cl. CPC G11B 27/3081; H04N 9/8227; G11B 27/326; H04N 5/93

(57) ABSTRACT

A method for the calibration of a camera for monitoring additive manufacturing of an object in which material is applied in a plurality of layers is provided. The method includes: a) providing the camera and providing means for additive manufacturing of the object, b) capturing an image of the object being manufactured or already manufactured by the camera, c) comparing the image captured with a model of the object, d) determining a calibration function on the basis of the comparison from step c), which is intended to transform the image captured into a corrected image, wherein the corrected image of the object substantially corresponds to the model of the object, and e) calibrating the camera by the calibration function. Also provided is a computer program comprising commands which, when executed by a computer, cause the computer to execute the steps of the method as well as a related apparatus.

### CROSS-REFERENCE TO RELATED APPLICATIONS

This application claims priority to PCT Application No. PCT/EP2020/058492, having a filing date of Mar. 26, 2020, which claims priority to EP Application No. 19169185.6, having a filing date of Apr. 15, 2019, the entire contents both of which are hereby incorporated by reference.

### FIELD OF TECHNOLOGY

The following relates to a method for calibrating a camera provided for monitoring an additive manufacturing method. It furthermore relates to a computer program comprising instructions which, when the program is executed by a computer, causes the latter to perform the steps of the method mentioned. Finally, the following relates to an apparatus comprising means for carrying out additive manufacturing of an object, a camera provided for monitoring the additive manufacturing method, and a calibration unit for calibrating the camera.

### BACKGROUND

The monitoring of an additive manufacturing method is important in order to recognize possible deviations in the process at an early stage and to be able to ensure the quality of the manufactured objects. Cameras are typically used for monitoring additive manufacturing methods, said cameras capturing and storing images during the manufacturing process.

In the course of capturing the images, it is possible for perspective distortions and geometric imaging aberrations to occur. The latter are referred to as distortions in the technical jargon, with a distinction being made between pincushion and barrel distortions. They are based on imaging aberrations that lead to a local change in the imaging scale in the lens equation. As a result, the captured object is not rendered true to scale, but rather in a distorted manner.

The region to be monitored by the camera generally comprises the build plate, on which the material to be processed is applied in the additive manufacturing method. The build plate generally has a basic area of at least 20 cm×20 cm, often even larger. The camera thus has to provide coverage of this area. Even if the distortions that occur are small and are only in the millimeters or even micrometers range, for example, they are unacceptable, under certain circumstances, for the high precision and quality requirements made of additive manufacturing methods.

For this reason, cameras that monitor an additive manufacturing process are conventionally calibrated. This means that an image captured by the camera is converted into a corrected image by a calibration function, said corrected image rendering the captured object ideally without distortions, i.e., true to scale.

The camera should at any rate be calibrated upon an initial installation in a 3D printing set-up. Further calibrations are recommendable in the case of mechanical changes in the set-up or at regular intervals for monitoring purposes.

In the conventional art, firstly the use of so-called calibration plates is known for the calibration. A calibration plate has a geometric pattern, e.g., a checkered pattern. The pattern is represented very precisely on the calibration plate and its shape is known very accurately. The calibration plate is positioned with a defined position and orientation in the apparatus for additive manufacturing. By way of example, the calibration plate is positioned on the build plate of the 3D printer. An image of the calibration plate is subsequently captured by the camera and compared with the previously known shape of the pattern represented on the calibration plate. A few points in the case of the checkered pattern, for example, a few selected intersection points—are typically used for this comparison; the comparison is effected with very high precision, however, in the pixel or subpixel range. On the basis of this comparison, a calibration function is ascertained which corrects the captured image insofar as the corrected image corresponds to the actual pattern of the calibration plate as well as possible.

One disadvantage of this calibration method is that it is relatively complex to carry out. Since the calibration plate has to be positioned very carefully at the predetermined location, the calibration takes a certain time and can generally be carried out only by trained personnel. Furthermore, productive operation has to be interrupted for this; in other words, the 3D printer is not available during the time in which the calibration method is carried out.

A further disadvantage of the calibration plate-based calibration method is that the user has to have such a calibration plate available. The calibration plate is generally kept by the original equipment manufacturer of the 3D printing device and is not available to everyone.

A second method known in the conventional art for calibrating a camera provided for monitoring an additive manufacturing method consists in using apparatus-specific reference markers, which are assumed to be invariable over time, as reference points for the calibration. In this case, apparatus-specific reference markers are understood to mean easily recognizable structural features on the 3D printing device, such as e.g., screw heads, corners or engraved markers, the position of which in the printing device is exactly known and is compared with that position in the image captured by the camera during the calibration method.

One disadvantage of this calibration method is that not every 3D printing device has such easily recognizable and unalterable apparatus-specific points. Furthermore, such reference markers can be partly or completely covered during the additive manufacturing method. This is the case particularly for beam melting methods such as selective laser melting. Here reference markers possibly present are often covered during the application of the pulverulent material, with the result that a reliable and precise identification of the reference markers is not ensured.

Against a background of this conventional art, the person skilled in the art addresses the problem of developing an alternative method for calibrating a camera provided for monitoring an additive manufacturing method, which alternative method overcomes at least some of the abovementioned disadvantages of conventional calibration methods. A further problem consists in providing a corresponding computer program and in providing a corresponding calibration apparatus.

### SUMMARY

An aspect relates to a method for calibrating a camera, wherein the camera is provided for monitoring additive manufacturing of an object, which involves applying material in a plurality of layers. The method comprises the following steps:

a) providing the camera and providing means for carrying out the additive manufacturing of the object,

b) capturing an image of the object being produced or the already completed object by means of the camera,

c) comparing the captured image with a pattern of the object,

d) determining a calibration function on the basis of the comparison from step c), said calibration function being provided for transforming the captured image into a corrected image, wherein the corrected image of the object substantially corresponds to the pattern of the object, and

e) calibrating the camera by the calibration function.

A “camera” is understood to mean a photographic apparatus which can record static or moving images electronically on a digital storage medium or can communicate them via an interface. In principle, it is also conceivable to capture images in analogue fashion on a photographic film, even if this variant is virtually no longer of practical significance nowadays.

“Additive manufacturing”, also referred to as 3D printing, is understood to mean manufacturing methods in which material is applied layer by layer and three-dimensional objects are thus produced. The object is constructed in a layered fashion under computer control from one or more solid or liquid materials according to predefined dimensions and shapes.

A central point of embodiments of the present invention is that instead of separately provided reference points on a calibration plate or selected apparatus-specific reference markers, the object being produced or the already completed object and its pattern are used for the calibration of the camera. Information about the geometry of the object itself that is to be manufactured is thus used to determine the extent of the distortions in the image of the object that is captured by the camera and to correct that. The geometric information about the object to be manufactured is generally present anyway; use of a separate calibration plate or the definition of recognizable reference markers on the 3D printing device is therefore no longer necessary.

The outlay in respect of having to procure and possibly keep ready a calibration plate for a specific 3D printing device is thus omitted. The calibration itself also becomes potentially simpler and faster since manual installation of the calibration plate is likewise omitted. One advantage of the present calibration method over the conventional calibration plate-based method is thus the lower outlay (in terms of metrology) and potentially faster determination of the calibration function.

Since conventionally a camera calibration is carried out only by trained personnel, time and (travel) costs can furthermore be saved with the present method since the present method no longer requires the presence of the trained personnel.

A further advantage of embodiments of the novel calibration method consists in the possibility of checking an existing calibration in an automated manner even during production. The system can thus monitor itself and recognize e.g., changes at the camera.

Yet another advantage of embodiments of the novel calibration method consists in being independent of the calibration plate or apparatus-specific reference markers made available. This is of importance particularly for additive manufacturing methods such as selective laser melting, in which the material to be processed is applied in powder form on the build plate, or for apparatuses that simply do not have any structural features with good suitability as reference markers.

Steps b)-e) of the method according to embodiments of the invention may proceed automatically, in other words in an automated fashion. The method according to embodiments of the invention can accordingly also be referred to as an automated method for calibrating a camera.

In an embodiment of the invention, the pattern corresponds to a sectional contour of a three-dimensional (3D) design model of the object.

The dimensions and shapes of the object to be printed are predefined by the so-called 3D design model. This involves a perspective representation of said object, which can be represented in general on a screen, for example a computer screen. In this case, the user can typically vary the perspective and thus view the represented object from different sides.

The 3D design model is generally designed in a computer-aided manner and is accordingly in particular a design model based on computer-aided design (CAD).

For additive manufacturing methods it is customary for a layer file to be present for each layer that is applied. In the simplest case, these files can contain just the description of the contours for each layer or else furthermore already information concerning the manufacturing process. Examples of conventional file formats are “Common Layer Interface” (CLI), “SLiCe (SLC) or “Parasolid” (with the file extension *.x_t). In an embodiment, the sectional contour is accordingly provided in a layer file, in particular having one of the two file formats mentioned above.

In a further embodiment, each layer applied in the manufacturing method is assigned an individual pattern, in particular an individual sectional contour, and the captured image is compared with that pattern which corresponds to the applied layer.

In a concrete example, it will be assumed that an object having a height of 3 cm is manufactured from a plurality of layers by selective laser melting. The layer thickness is 30 μm. The object thus consists of 1000 layers. An individual layer file exists for each layer. Said file contains the contour of the object in the respective layer (or: height) of the object and, optionally, process parameters for the application of the pulverulent material and/or settings of the laser for the remelting of the powder. If, for example, precisely the 267^{th} layer is then produced and the camera captures an image of the object, a good quarter of which has now been completed, this captured image is expediently compared with that layer file which contains the sectional contour of the 267^{th} layer. A suitable calibration function can then be determined from the geometric deviations in the image captured by the camera and from the corresponding individual layer file.

The layer file generally contains for each pixel the information of whether or not at this point a (further) layer is to be applied to the object being produced. However, the camera image representing the object after the application of this layer shows the object with possible shadings, mirrorings and similar effects. Furthermore, the camera image shows a background surrounding the object, for example, the non-remelted powder bed and parts of the 3D printing device. In an embodiment of the invention, therefore, after the image has been captured, the object in the captured image is segmented and the segmented image is subsequently compared with the pattern.

Automatic methods for image segmentation are sufficiently known to the person skilled in the art from the field of digital image processing and machine vision. The term image segmentation denotes the generation of regions interrelated in their contents by the combination of adjacent pixels or voxels according to a predetermined homogeneity criterion. Image processing programs such as the freely available “scikit-image” offer segmentation algorithms and higher image processing algorithms on the basis of various segmentation algorithms.

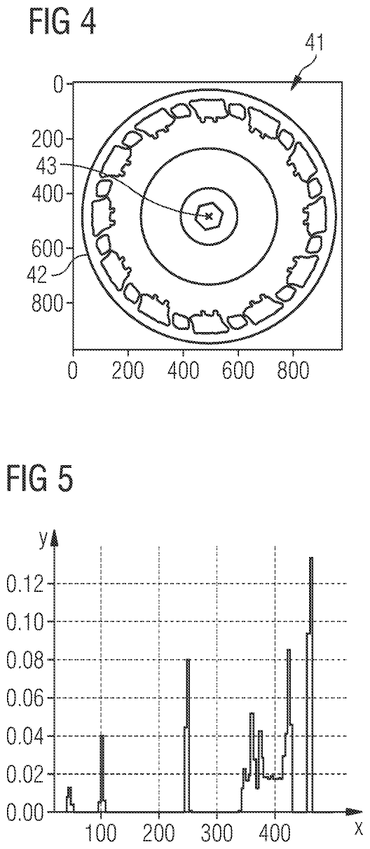

In a first alternative, the comparison between the captured image, in which the relevant object was segmented, as just described, and the pattern is effected by a comparison of the distances between selected reference points. Suitable reference points can be real points, e.g., corner points, of the object. Suitable reference points can be also fictitious reference points. If the object consists of a plurality of rotationally symmetrical objects, for example, a fictitious center point can be calculated for each rotationally symmetrical object and can then be used as a reference point. One example of this is illustrated in FIG. 4 and explained in greater detail in the corresponding description. The respective distances between the reference points are determined once for the object represented in the camera image and once for the corresponding pattern. The use of Euclidean distances is appropriate here. A distortion of the camera image can be deduced from possible deviations of the distances.

In a second alternative, the outline of the object is used for the comparison between the captured image and the pattern. A plurality of the pixels describing the object are thus used for the comparison between the captured image and the pattern.

Both alternatives, but in particular the second alternative, constitute a fundamental conceptual difference with respect to conventional calibration methods. In the conventional art, typically a few points (e.g., intersection points on a calibration plate or apparatus-specific reference markers) in the captured image are compared with the comparison object; this comparison is carried out with very high precision, however. In embodiments of the present invention, by contrast, a plurality of reference points are used for the comparison between the camera image and the pattern. If a large quantity of pixels are taken into account in the calibration, less stringent requirements can be made of the precision of the comparison. This is based on the fact that in the case of a large quantity of comparison values, statistical aspects may also play a part in the comparison.

In an embodiment of the invention, the Kullback-Leibler divergence of the two frequency distributions representing in each case the distance between the respective pixels describing the outline of the object and a reference point is used as a measure of the similarity of the captured image and the pattern.

The Kullback-Leibler divergence (KL divergence for short), which is also called Kullback-Leibler entropy, Kullback-Leibler distance or “information gain”, generally denotes a measure of the difference between two probability distributions. In this case, one of the distributions typically represents empirical observations (here the camera image), while the other represents a model or an approximation (here the pattern, for example the layer file).

Specifically, in this embodiment, the frequency distribution of the measured distances between those pixels which describe the outline of the object and a reference point for the (segmented) camera image are compared with the frequency distribution of the ascertained distances between the pixels and the same reference point for the pattern. If they match, it can be deduced that the camera image renders the pattern true to scale. However, if the frequency distribution of the camera image is in any way shifted, widened or otherwise different in relation to the frequency distribution of the pattern, this is an indication of a distorted representation in the camera image.

If the object consists of a plurality of objects (or: individual components), in an embodiment the outlines of a plurality, in particular all, of the objects of the object may be used for the comparison.

The calibration function in step d) of the method can be determined for example specifically by the following steps:

d1) initializing the calibration function with initialization parameters (θᵢ),

d2) transforming the captured image into a corrected image by the calibration function,

d3) determining the deviation (E) between the corrected image and the pattern,

d4) changing the parameters (θ) of the calibration function in order to reduce the deviation (E),

d5) repeating steps d2) to d4) until the deviation is less than a predetermined threshold value.

The parameters of the calibration function can concern perspective distortions, (barrel and pincushion) distortions, but al so translational and rotational corrections. The calibration function is ideally initialized with initialization parameters taken from a coarse precalibration or an earlier calibration at the same 3D printing device.

The deviation between the corrected image and the pattern can be quantified with a scalar that characterizes the distances between the reference points. The deviation can also be characterized by the Kullback-Leibler divergence of the two frequency distributions, particularly if the outlines of the object are used for the comparison.

The determination of the calibration function is generally stabler and more robust if its parameters are determined not just for one layer, but for a plurality of layers. In embodiments it is thus advantageous for the calibration of the camera to be based on a plurality of comparisons that are carried out for different layers.

Embodiments of the present invention are applicable, in principle, to any type of additive manufacturing. However, it can be applied to beam melting methods with particularly great benefit. In other words, embodiments of the present invention can advantageously be implemented in additive manufacturing methods in which
a material to be processed is applied in a thin layer in powder form on a build plate,
after layer application, the pulverulent material is locally remelted by laser radiation,
the remelted layer forms a solid material layer after it has solidified, and
this cycle is repeated until the object to be manufactured has attained its planned shape and size.

One example of such a method is selective laser melting. Selective laser melting (SLM) is also referred to as “Laser Powder Bed Fusion” (LPBF or L-PBF). Beam melting methods similar to selective laser melting are electron beam melting and selective laser sintering.

In the case of selective laser melting, the material to be processed is applied in powder form in a thin layer on a build plate. The pulverulent material is locally completely remelted by laser radiation and forms a solid material layer after solidification. Afterward, the build plate is lowered by the magnitude of a layer thickness and powder is applied once again. This cycle is repeated until all layers have been remelted. Excess powder is cleaned away from the finished component and the latter is if necessary processed or used immediately.

The typical layer thicknesses for the construction of the component range between 15 and 500 μm for all materials.

The data for guiding the laser beam are generated from a 3D design model, e.g., a 3D CAD body, by software. In the first calculation step, the component is subdivided into individual layers. In the second calculation step, the paths (vectors) traversed by the laser beam are generated for each layer. In order to avoid contamination of the material with oxygen, the process usually takes place under a protective gas atmosphere comprising argon or nitrogen.

Components manufactured by selective laser melting are distinguished by high relative densities (>99%). This ensures that the mechanical properties of the additively manufactured component largely correspond to those of the basic material. However, it is also possible to manufacture a component with selective densities in a targeted manner, according to bionic principles or in order to ensure a partial modulus of elasticity. In lightweight aerospace construction and body implants, such selective elasticities within a component are often desired and cannot be produced in this way using conventional methods.

Compared with conventional methods (casting methods), laser melting is distinguished by the fact that mold tools or molds are obviated (moldless manufacturing) and the time to market can be reduced as a result. A further advantage is the great freedom in terms of geometry, which makes it possible to manufacture component shapes which cannot be produced or can be produced only with a great outlay using mold-based methods. Furthermore, storage costs can be reduced since specific components do not have to be kept in stock, but rather are additively manufactured as required.

In an embodiment, the camera image of the object being produced or the already completed object is captured after the melting by the laser radiation and before the application of the pulverulent material for the next material layer. In the technical jargon, melting by laser radiation is also referred to as “exposure”, and the application of the pulverulent material for the next material layer as “recoating”. In an embodiment, the camera image is thus captured between exposure and recoating. The reason for this is that the melted layer typically has a significantly different reflectivity than the powder that has not been treated (irradiated), with the result that the object after the exposure is generally well distinguishable from the surrounding powder bed. After the recoating, the object is generally not visible, or only barely visible, since the entire build plate is covered by a largely homogeneous powder layer.

In an embodiment of the invention, the calibration is carried out automatically at predefined points in time and, in the case of changes in the calibration function, a user is informed in particular by way of a warning indication.

In order to have available unequivocal and irrefutable documentation indicating the calibration of the camera, in an embodiment it can be advantageous to archive the calibration function used in a blockchain.

Embodiments of the invention furthermore relate to a computer program, comprising instructions which, when the program is executed by a computer, cause the latter to perform the steps of any of the methods disclosed.

Finally, embodiments of the invention also relate to an apparatus comprising i) means for carrying out additive manufacturing of an object, which involves applying material in a plurality of layers, ii) a camera provided for monitoring the additive manufacturing of the object, and iii) a calibration unit for calibrating the camera, wherein the calibration unit is configured
to cause the capture of an image of the object being produced or the already completed object by the camera,
to compare the captured image with a pattern of the object,
to determine a calibration function on the basis of the comparison carried out, wherein the calibration function is provided for transforming the captured image into a corrected image, wherein the corrected image of the object substantially corresponds to the pattern of the object, and
to calibrate the camera by the calibration function.

Any features that have been disclosed in association with exemplary embodiments and variants of the method are correspondingly applicable to the stated apparatus.

### BRIEF DESCRIPTION

Some of the embodiments will be described in detail, with references to the following Figures, wherein like designations denote like members, wherein:

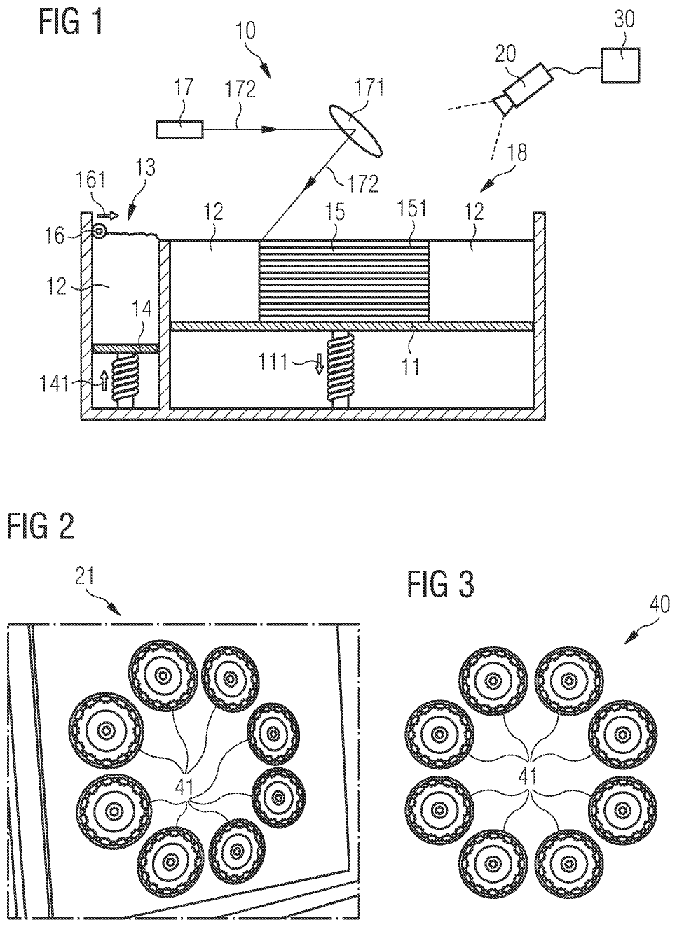

FIG. 1 illustrates an apparatus comprising a 3D printing device, a camera and a calibration unit, according to an embodiment;

FIG. 2 illustrates an image of an object being produced, said image having been captured by a camera, according to an embodiment;

FIG. 3 illustrates a pattern associated with the image from FIG. 2;

FIG. 4 illustrates the outline of an individual component from the pattern from FIG. 3; and

FIG. 5 illustrates a histogram of the distances between the outline and a reference point of the individual component represented in FIG. 4.

### DETAILED DESCRIPTION

FIG. 1 shows an apparatus comprising a 3D printing device 10, a camera 20 and a calibration unit 30. An apparatus for selective laser melting is shown by way of example as 3D printing device 10. The 3D printing device 10 has a material supply container 13 for filling with material 12. Furthermore, the printing device 10 has a printing region 18, in which the object to be manufactured is produced. The material 12 is present in powder form and contains for example a metal or a metallic compound. The material supply container 13 has side walls and an adjustable base 14. The base 14 is height-adjustable, such that the volume of the material supply container 13 is variable. The height of the base 14 of the material supply container 13 is able to be set or regulated by a controller and corresponding actuators.

The printing region 18 likewise has a height-adjustable base, the so-called build plate 11. The build plate 11, too, is able to be set or regulated by a controller and corresponding actuators. The object 15 being produced is situated on the build plate 11. At the beginning of the manufacturing process, the height of the build plate 11 is maximal. It moves downward in the direction of the arrow bearing the reference sign 111 during the construction of the material layers 151 of the object. The direction 141 of movement of the base 14 of the material supply container 13, said direction being identified by the arrow bearing the reference sign 141, is opposite to the direction 111 of movement of the build plate 11.

A roller 16 distributes material 12 from the material supply container 13 uniformly into the printing region 18. Customary layer thicknesses in selective laser melting are in the range of 15 μm to 500 μm. After the pulverulent material 12 has been distributed this process is also referred to as “recoating” in the technical jargon -, in a predefined region the material 12 is irradiated with a laser beam 172, the so-called exposure. The laser beam 172 is emitted by a laser 17 and is directed onto a desired point by a deflection mirror 171 mounted in a rotatable fashion. The pulverulent material 12 is locally completely remelted by laser radiation and forms a solid material layer 151 after solidification. The build plate 11 is subsequently lowered by the magnitude of a layer thickness and material 12 is applied once again. This cycle is repeated until all material layers have been remelted.

A camera 20 is positioned such that it can capture an image of the build plate 11 covered with the material 12 and of the object 15 being produced. However, it is generally unavoidable that the image captured by the camera 20 has distortions or similar artefacts. Consequently, a calibration of the camera 20 that corrects these optical effects is necessary.

In the conventional art, cameras are calibrated by calibration plates, for example. Instead of the use of a calibration plate, embodiments of the present invention propose the comparison of an image of the object being produced, or the already completed object, with a pattern. FIG. 2 shows an image 21 of an object, said image having been captured by a camera. Here the object consists of eight identical ring-shaped individual components. The fact of whether the object is still being produced or else it is already possible to see the finished object after laser irradiation (exposure) of the last layer is irrelevant to the elucidation of the inventive concept. In any case FIG. 3 shows the corresponding pattern 40, in this case from a layer file, which is assigned to the material layer represented in the image in FIG. 2.

It is already possible to discern with the naked eye that the image of the object that can be seen in FIG. 2 is distorted in comparison with the pattern illustrated in FIG. 3. By a calibration function, this distorted image is intended to be corrected so that it substantially corresponds to the pattern.

For this purpose, e.g., the frequency distributions (also called histograms) of the pixels representing the outline of the object of the captured image and of the pattern can be compared. Specifically, in this case the distances of the pixels of the outline in relation to a reference point are represented in the histograms and compared.

The object shown by way of example in FIGS. 2 and 3 has eight individual components 41 of identical type, which are separated from one another. It is appropriate to compare the frequency distributions for each of the individual components 41 separately.

FIG. 4 shows the outline 42 of an individual component 41 of the object mentioned. The resolution of the camera has already been taken into account here, which is why the outline shown in FIG. 5 has a certain unsharpness. The center point, that is to say the center, of the individual component is chosen as a reference point 43.

FIG. 5 shows the frequency distribution of the distances of the pixels of the outline 42 shown in FIG. 4. The distance from the reference point 53 (in millimeters) is plotted on the x-axis, and the relative frequency is plotted on the y-axis.

This frequency distribution is then to be compared with the frequency distribution of an individual component such as can be seen in the captured image 21 in FIG. 2. It will become apparent that the frequency distributions deviate from one another. By optimizing the parameters of the calibration function, an attempt should then be made to attain a (relative) minimum of the Kullback-Leibler divergence.

A calibration of the camera monitoring the additive manufacturing is thus possible, without, as in the conventional art, having recourse to a calibration plate or apparatus-specific reference markers.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for calibrating a camera, wherein the camera is provided for monitoring additive manufacturing of an object, which involves applying material in a plurality of layers, and wherein the method comprises:
a) providing the camera and providing means for carrying out the additive manufacturing of the object,
b) capturing an image of the object being produced or the already completed object by the camera,
c) comparing the captured image with a pattern of the object,
d) determining a calibration function on the basis of the comparison from step c), said calibration function being provided for transforming the captured image into a corrected image, wherein the corrected image of the object substantially corresponds to the pattern of the object, and
e) calibrating the camera by the calibration function.

2. The method as claimed in claim 1, wherein the pattern corresponds to a sectional contour of a 3D design model of the object.

3. The method as claimed in claim 2, wherein the sectional contour is provided as a layer file.

4. The method as claimed in claim 1, wherein each respective layer applied in the additive manufacturing is assigned a respective individual pattern, in particular an individual sectional contour, and wherein the captured image is compared with the respective pattern which corresponds to the respective layer applied.

5. The method as claimed in claim 1, wherein after the image has been captured, the object in the captured image is segmented and the segmented image is subsequently compared with the pattern.

6. The method as claimed in claim 1, wherein the comparison between the captured image and the pattern includes a comparison of distances between selected reference points.

7. The method as claimed in claim 1, wherein an outline of the object is used for the comparison between the captured image and the pattern.

8. The method as claimed in claim 7, wherein a Kullback-Leibler divergence of two frequency distributions representing in each case a distance between the respective pixels describing the outline of the object and a reference point is used as a measure of a similarity of the captured image and the pattern.

9. The method as claimed in claim 1, wherein the calibration function is determined by the following steps:
d1) initializing the calibration function with initialization parameters,
d2) transforming the captured image into the corrected image by the calibration function,
d3) determining a deviation between the corrected image and the pattern,
d4) changing the parameters of the calibration function in order to reduce the deviation,
d5) repeating steps d2) to d4) until the deviation is less than a predetermined threshold value.

10. The method as claimed in claim 1, wherein in the additive manufacturing
a material to be processed is applied in a thin layer in powder form on a build plate,
after layer application, the pulverulent material is locally remelted by laser radiation,
the remelted layer forms a solid material layer after it has solidified, and
this cycle is repeated until the object to be manufactured has attained its planned shape and size.

11. The method as claimed in claim 10, wherein the image is captured in accordance with step b) after the remelting by the laser radiation and before the application of the pulverulent material for a next material layer.

12. The method as claimed in claim 1, wherein the calibration is carried out automatically at predefined points in time and, in the case of changes in the calibration function, a user is informed.

13. The method as claimed in claim 1, wherein the calibration function is stored in a blockchain.

14. A computer program, comprising instructions which, when the program is executed by a computer, cause the computer to perform the method as claimed in claim 1.

15. An apparatus comprising means for carrying out additive manufacturing of an object, which involves applying material in a plurality of layers, a camera provided for monitoring the additive manufacturing of the object, and a calibration unit for calibrating the camera, wherein the calibration unit is configured
to cause capture of an image of the object being produced or already completed by the camera,
to compare the captured image with a pattern of the object,
to determine a calibration function on the basis of the comparison, wherein the calibration function is provided for transforming the captured image into a corrected image, wherein the corrected image of the object substantially corresponds to the pattern of the object, and
to calibrate the camera by the calibration function.
